(19) United States
(12) Patent Application Publication
(10) Pub. No.: US 2025/0190376 A1
(43) Pub. Date: Jun. 12, 2025

(54) COMMAND FENCING FOR MEMORY-BASED COMMUNICATION QUEUES

(71) Applicant: Micron Technology, Inc., Boise, ID (US)

(72) Inventors: Tony M. Brewer, Plano, TX (US); Michael Keith Dugan, Richardson, TX (US)

(21) Appl. No.: 18/846,483

(22) PCT Filed: Mar. 31, 2023
(86) PCT No.: PCT/US2023/017120

§ 371 Date: Sep. 12, 2024

Related U.S. Application Data
(60) Provisional application No. 63/348,327, filed on Jun. 2, 2022.

(51) Int. Cl. G06F 13/16; G06F 13/42

(52) U.S. Cl. CPC G06F 13/1642; G06F 13/1668; G06F 13/426

(57) ABSTRACT

A command manager can be configured to enforce respective command execution policies for each of multiple queues according to respective command fence instructions. In an example, the command manager can be configured to receive a first packet comprising a first fence instruction and a first command for a first queue and, responsive to the first fence instruction indicating fence participation, increment a fence counter and provide the first command to a command execution unit, such as a memory controller of a memory device. The command manager can receive a first response message from the command execution unit based on the first command and can decrement the fence counter. In an example, the command manager comprises a portion of an accelerator device that uses an unordered interconnect, such as a Compute Express Link (CXL) interconnect, to communicate with a host device.

### PRIORITY APPLICATION

This application claims the benefit of priority to U.S. Provisional Application Ser. No. 63/348,327, filed Jun. 2, 2022, which is incorporated herein by reference in its entirety.

### STATEMENT REGARDING FEDERALLY SPONSORED RESEARCH OR DEVELOPMENT

This invention was made with Government support under Agreement No. DE-AC05-76RL01830, awarded by the US Department of Energy. The Government has certain rights in the invention.

### TECHNICAL FIELD

Embodiments pertain to memory devices. Some embodiments pertain to command fencing in memory devices.

### BACKGROUND

Memory devices for computers or other electronic devices may be categorized as volatile and non-volatile memory. Volatile memory requires power to maintain its data, and includes random-access memory (RAM), dynamic random-access memory (DRAM), or synchronous dynamic random-access memory (SDRAM), among others. Non-volatile memory can retain stored data when not powered, and includes flash memory, read-only memory (ROM), electrically erasable programmable ROM (EEPROM), static RAM (SRAM), erasable programmable ROM (EPROM), resistance variable memory, phase-change memory, storage class memory, resistive random-access memory (RRAM), and magnetoresistive random-access memory (MRAM), among others. Persistent memory is an architectural property of the system where the data stored in the media is available after system reset or power-cycling. In some examples, non-volatile memory media may be used to build a system with a persistent memory model.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system.

Various protocols or standards can be applied to facilitate communication between a host and one or more other devices such as memory buffers, accelerators, or other input/output devices. In an example, an unordered protocol such as Compute Express Link (CXL) can be used to provide high-bandwidth and low-latency connectivity.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates generally a block diagram of an example computing system including a host and a memory device.

FIG. 2 illustrates generally an example of a compute express link (CXL) system.

FIG. 3 illustrates generally an example of a command fencing protocol diagram.

FIG. 4 illustrates generally a portion of a command fencing protocol.

FIG. 5 illustrates generally a portion of a command fencing protocol.

FIG. 6 illustrates a block diagram of an example machine with which, in which, or by which any one or more of the techniques discussed herein can be implemented.

### DETAILED DESCRIPTION

Compute Express Link (CXL) is an open standard interconnect configured for high-bandwidth, low-latency connectivity between host devices and other devices such as accelerators, memory buffers, and other I/O devices. CXL was designed to facilitate high-performance computational workloads by supporting heterogeneous processing and memory systems. CXL enables coherency and memory semantics on top of PCI Express (PCIe)-based I/O semantics for optimized performance.

In some examples, CXL is used in applications such as artificial intelligence, machine learning, analytics, cloud infrastructure, edge computing devices, communication systems, and elsewhere. Data processing in such applications can use various scalar, vector, matrix and spatial architectures that can be deployed in CPU, GPU, FPGA, smart NICs, or other accelerators that can be coupled using a CXL link.

CXL supports dynamic multiplexing using a set of protocols that includes input/output (CXL.io, based on PCIe), caching (CXL.cache), and memory (CXL.memory) semantics. In an example, CXL can be used to maintain a unified, coherent memory space between the CPU (e.g., a host device or host processor) and any memory on the attached CXL device. This configuration allows the CPU and the CXL device to share resources and operate on the same memory region for higher performance, reduced data movement, and reduced software stack complexity. In an example, the CPU is primarily responsible for maintaining or managing coherency in a CXL environment. Accordingly, CXL can be leveraged to help reduce device cost and complexity, as well as overhead traditionally associated with coherency across an I/O link.

CXL runs on PCIe PHY and provides full interoperability with PCIe. In an example, a CXL device starts link training in a PCIe Gen 1 Data Rate and negotiates CXL as its operating protocol (e.g., using the alternate protocol negotiation mechanism defined in the PCIe 5.0 specification) if its link partner supports CXL. Devices and platforms can thus more readily adopt CXL by leveraging the PCIe infrastructure and without having to design and validate the PHY, channel, channel extension devices, or other upper layers of PCIe.

In an example, CXL supports single-level switching to enable fan-out to multiple devices. This enables multiple devices in a platform to migrate to CXL, while maintaining backward compatibility and the low-latency characteristics of CXL. In an example, CXL can provide a standardized compute fabric that supports pooling of multiple logical devices (MLD) and single logical devices such as using a CXL switch connected to several host devices or nodes (e.g., Root Ports). This feature enables servers to pool resources such as accelerators and/or memory that can be assigned according to workload. For example, CXL can help facilitate resource allocation or dedication and release. In an example, CXL can help allocate and deallocate memory to various host devices according to need. This flexibility helps designers avoid over-provisioning while ensuring best performance.

Some of the compute-intensive applications and operations mentioned herein can require or use large data sets. Memory devices that store such data sets can be configured for low latency and high bandwidth and persistence. One problem of a load-store interconnect architecture includes guaranteeing persistence. CXL can help address the problem using an architected flow and standard memory management interface for software, such as can enable movement of persistent memory from a controller-based approach to direct memory management.

The present inventors have recognized that a problem to be solved includes maintaining ordering in command execution. For example, operation execution and timing issues can arise in unordered systems, such as including systems that use CXL. In an example, a host device can create a series of commands that it queues for execution by an accelerator (e.g., a CXL device). The accelerator can retrieve or receive the commands from the queue and execute the commands in order (e.g., in a first-in, first-out manner). In some applications, maintaining order can be critical to optimizing performance and ensuring valid results. For example, operation order enforcement can be important for performing nested loops or matrix computations, where results from earlier operations are used in later operations.

The present inventors have recognized that a solution to the computation ordering problem can include or use command fencing, or a memory barrier, to enforce a particular ordering of commands, such as reads and writes in a memory system. In an example, a host device can be configured to specify whether a particular command participates in a fenced operation, or whether the particular command is required to wait until earlier fenced commands are completed. In an example, the solution can include one or more state bits appended to, or comprising a portion of, a command message to indicate whether a particular command participates in or initiates a command fence. A command execution unit, such as a processor or other downstream operator, can be inhibited from reordering instructions or operations across an established fence. In some examples, a command message can have its state bits configured such that the command can pass through an established fence.

The fencing protocols, or fence protocols, discussed herein can be implemented in or using a command manager for an accelerator or CXL device. The command manager can be configured to enforce respective command execution policies for each of multiple queues according to respective command fence instructions. The command manager can be further configured to receive a first packet comprising a first fence instruction and a first command for a first queue, and responsive to the first fence instruction indicating fence participation, the command manager can increment a fence counter and provide the first command to a command execution unit. The command manager can later receive a first response from the command execution unit that is based on the first command and can decrement the fence counter. In an example, the command execution unit includes or uses a general or purpose-built processor, or group of processors, such as including a threading engine, a streaming engine, a memory controller of a memory device, a data mover, or other functional unit. Command and response pairs can be tracked through one or more command execution units using transaction identifiers or other techniques.

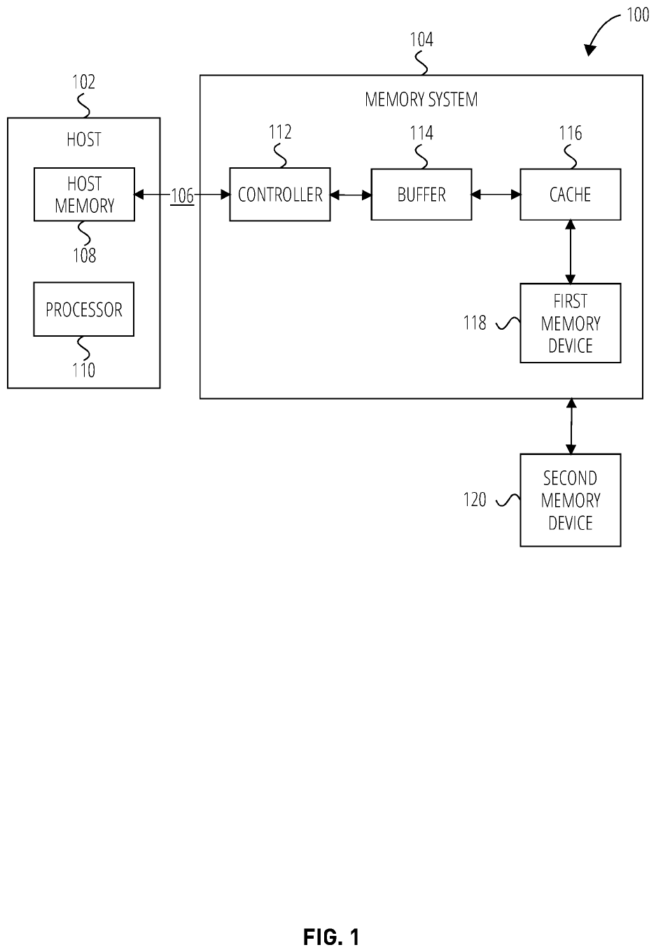

FIG. 1 illustrates generally a block diagram of an example of a computing system 100 including a host device 102 and a memory system 104. The host device 102 includes a central processing unit (CPU) or processor 110 and a host memory 108. In an example, the host device 102 can include a host system such as a personal computer, a desktop computer, a digital camera, a smart phone, a memory card reader, and/or Internet-of-things enabled device, among various other types of hosts, and can include a memory access device, e.g., the processor 110. The processor 110 can include one or more processor cores, a system of parallel processors, or other CPU arrangement.

The memory system 104 includes a controller 112, a buffer 114, a cache 116, and a first memory device 118. The first memory device 118 can include, for example, one or more memory modules (e.g., single in-line memory modules, dual in-line memory modules, etc.). The first memory device 118 can include volatile memory and/or non-volatile memory, and can include a multiple-chip device that comprises one or multiple different memory types or modules. In an example, the computing system 100 includes a second memory device 120 that interfaces with the memory system 104 and the host device 102.

The host device 102 can include a system backplane and can include a number of processing resources (e.g., one or more processors, microprocessors, or some other type of controlling circuitry). The computing system 100 can optionally include separate integrated circuits for the host device 102, the memory system 104, the controller 112, the buffer 114, the cache 116, the first memory device 118, the second memory device 120, any one or more of which may comprise respective chiplets that can be connected and used together. In an example, the computing system 100 includes a server system and/or a high-performance computing (HPC) system and/or a portion thereof. Although the example shown in FIG. 1 illustrates a system having a Von Neumann architecture, embodiments of the present disclosure can be implemented in non-Von Neumann architectures, which may not include one or more components (e.g., CPU, ALU, etc.) often associated with a Von Neumann architecture.

In an example, the first memory device 118 can provide a main memory for the computing system 100, or the first memory device 118 can comprise accessory memory or storage for use by the computing system 100. In an example, the first memory device 118 or the second memory device 120 includes one or more arrays of memory cells, e.g., volatile and/or non-volatile memory cells. The arrays can be flash arrays with a NAND architecture, for example. Embodiments are not limited to a particular type of memory device. For instance, the memory devices can include RAM, ROM, DRAM, SDRAM, PCRAM, RRAM, and flash memory, among others.

In embodiments in which the first memory device 118 includes persistent or non-volatile memory, the first memory device 118 can include a flash memory device such as a NAND or NOR flash memory device. The first memory device 118 can include other non-volatile memory devices such as non-volatile random-access memory devices (e.g., NVRAM, ReRAM, FeRAM, MRAM, PCM), memory devices such as a ferroelectric RAM device that includes ferroelectric capacitors that can exhibit hysteresis characteristics, a 3-D Crosspoint (3D XP) memory device, etc., or combinations thereof.

In an example, the controller 112 comprises a media controller such as a non-volatile memory express (NVMe) controller. The controller 112 can be configured to perform operations such as copy, write, read, error correct, etc. for the first memory device 118. In an example, the controller 112 can include purpose-built circuitry and/or instructions to perform various operations. That is, in some embodiments, the controller 112 can include circuitry and/or can be configured to perform instructions to control movement of data and/or addresses associated with data such as among the buffer 114, the cache 116, and/or the first memory device 118 or the second memory device 120.

In an example, at least one of the processor 110 and the controller 112 comprises a command manager (CM) for the memory system 104. The CM can receive, such as from the host device 102, a read command for a particular logic row address in the first memory device 118 or the second memory device 120. In some examples, the CM can determine that the logical row address is associated with a first row based at least in part on a pointer stored in a register of the controller 112. In an example, the CM can receive, from the host device 102, a write command for a logical row address, and the write command can be associated with second data. In some examples, the CM can be configured to issue, to non-volatile memory and between issuing the read command and the write command, an access command associated with the first memory device 118 or the second memory device 120. In some examples, the CM can issue, to the non-volatile memory and between issuing the read command and the write command, an access command associated with the first memory device 118 or the second memory device 120.

In an example, the buffer 114 comprises a data buffer circuit that includes a region of a physical memory used to temporarily store data, for example, while the data is moved from one place to another. The buffer 114 can include a first-in, first-out (FIFO) buffer in which the oldest (e.g., the first-in) data is processed first. In some embodiments, the buffer 114 includes a hardware shift register, a circular buffer, or a list.

In an example, the cache 116 comprises a region of a physical memory used to temporarily store particular data that is likely to be used again. The cache 116 can include a pool of data entries. In some examples, the cache 116 can be configured to operate according to a write-back policy in which data is written to the cache without the being concurrently written to the first memory device 118. Accordingly, in some embodiments, data written to the cache 116 may not have a corresponding data entry in the first memory device 118.

In an example, the controller 112 can receive write requests (e.g., from the host device 102) involving the cache 116 and cause data associated with each of the write requests to be written to the cache 116. In some examples, the controller 112 can receive the write requests at a rate of thirty-two (32) gigatransfers (GT) per second, such as according to or using a CXL protocol. The controller 112 can similarly receive read requests and cause data stored in, e.g., the first memory device 118 or the second memory device 120, to be retrieved and written to, for example, the host device 102 via an interface 106.

In an example, the interface 106 can include any type of communication path, bus, or the like that allows information to be transferred between the host device 102 and the memory system 104. Non-limiting examples of interfaces can include a peripheral component interconnect (PCI) interface, a peripheral component interconnect express (PCIe) interface, a serial advanced technology attachment (SATA) interface, and/or a miniature serial advanced technology attachment (mSATA) interface, among others. In an example, the interface 106 includes a PCIe 5.0 interface that is compliant with the compute express link (CXL) protocol standard. Accordingly, in some embodiments, the interface 106 supports transfer speeds of at least 32 GT/s.

As similarly described elsewhere herein, CXL is a high-speed central processing unit (CPU)-to-device or CPU-to-memory interconnect designed to enhance compute performance. CXL technology maintains memory coherency between a CPU memory space (e.g., the host memory 108) and memory on attached devices or accelerators (e.g., the first memory device 118 or the second memory device 120), which allows resource sharing for higher performance, reduced software stack complexity, and lower overall system cost. CXL is designed to be an industry open standard interface for high-speed communications as accelerators are increasingly used to complement CPUs in support of emerging data-rich and compute-intensive applications such as artificial intelligence and machine learning.

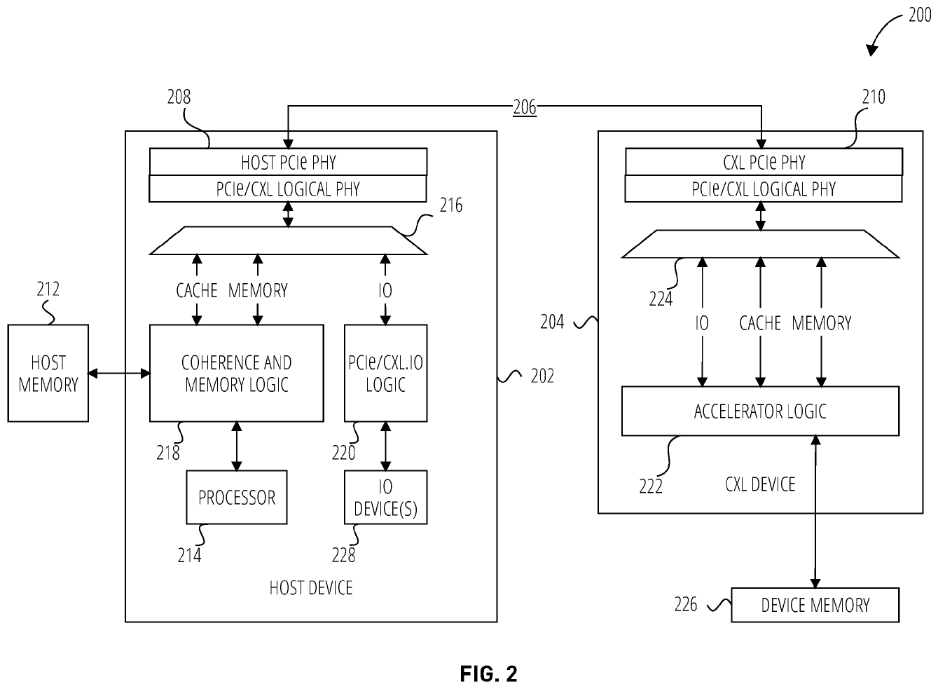

FIG. 2 illustrates generally an example of a CXL system 200 that uses a CXL link 206 to connect a host device 202 and a CXL device 204. In an example, the host device 202 comprises or corresponds to the host device 102 and the CXL device 204 comprises or corresponds to the memory system 104 from the example of the computing system 100 in FIG. 1. A memory system command manager (CM) can comprise a portion of the host device 202 or the CXL device 204. In an example, the CXL link 206 (e.g., corresponding to the interface 106 from the example of FIG. 1) can support communications using multiplexed protocols for caching (e.g., CXL.cache), memory accesses (e.g., CXL.mem or CXL.memory), and data input/output transactions (e.g., CXL.io). CXL.io can include a protocol based on PCIe that is used for functions such as device discovery, configuration, initialization, I/O virtualization, and direct memory access (DMA) using non-coherent load-store, producer-consumer semantics. CXL.cache can enable a device to cache data from the host memory (e.g., from the host memory 212) using a request and response protocol. CXL.memory can enable the host device 202 to use memory attached to the CXL device 204, for example, in or using a virtualized memory space. In an example, CXL.memory transactions can be memory load and store operations that run downstream from or outside of the host device 202.

In the example of FIG. 2, the host device 202 includes a host processor 214 (e.g., comprising one or more CPUs or cores) and IO device(s) 228. The host device 202 can comprise, or can be coupled to, host memory 212. The host device 202 can include various circuitry or logic configured to facilitate CXL-based communications and transactions with the CXL device 204. For example, the host device 202 can include coherence and memory logic 218 configured to implement transactions according to CXL.cache and CXL.memory semantics, and the host device 202 can include PCIe logic 220 configured to implement transactions according to CXL.io semantics. In an example, the host device 202 can be configured to manage coherency of data cached at the CXL device 204 using, e.g., its coherence and memory logic 218.

The host device 202 can further include a host multiplexer 216 configured to modulate communications over the CXL link 206 (e.g., using the PCIe PHY layer). The multiplexing of protocols ensures that latency-sensitive protocols (e.g., CXL.cache and CXL.memory) have the same or similar latency as a native processor-to-processor link. In an example, CXL defines an upper bound on response times for latency-sensitive protocols to help ensure that device performance is not adversely impacted by variation in latency between different devices implementing coherency and memory semantics.

In an example, symmetric cache coherency protocols can be difficult to implement between host processors because different architectures may use different solutions, which in turn can compromise backward compatibility. CXL can address this problem by consolidating the coherency function at the host device 202, such as using the coherence and memory logic 218.

The CXL device 204 can include an accelerator device that comprises various accelerator logic 222. In an example, the CXL device 204 can comprise, or can be coupled to, CXL device memory 226. The CXL device 204 can include various circuitry or logic configured to facilitate CXL-based communications and transactions with the host device 202 using the CXL link 206. For example, the accelerator logic 222 can be configured to implement transactions according to CXL.cache, CXL.memory, and CXL.io semantics. The CXL device 204 can include a CXL device multiplexer 224 configured to control communications over the CXL link 206.

In an example, one or more of the coherence and memory logic 218 and the accelerator logic 222 comprises a Unified Assist Engine (UAE) or compute fabric with various functional units such as a command manager (CM), Threading Engine (TE), Streaming Engine (SE), Data Manager or data mover (DM), or other unit. The compute fabric can be reconfigurable and can include separate synchronous and asynchronous flows.

The accelerator logic 222 or portions thereof can be configured to operate in an application space of the CXL system 200 and, in some examples, can initiate its own threads or sub-threads, which can operate in parallel and can optionally use resources or units on other CXL devices 204. Queue and transaction control through the system can be coordinated by the CM, TE, SE, or DM components of the UAE. In an example, each queue or thread can map to a different loop iteration to thereby support multi-dimensional loops. With the capability to initiate such nested loops, among other capabilities, the system can realize significant time savings and latency improvements for compute-intensive operations.

In an example, command fencing can be used to help maintain order throughout such operations, which can be performed locally or throughout a compute space of the accelerator logic 222. In some examples, the CM can be used to route commands to a particular command execution unit (e.g., comprising the accelerator logic 222 of a particular instance of the CXL device 204) using an unordered interconnect that provides respective transaction identifiers (TID) to command and response message pairs.

In the CXL system 200, the host device 202 can provide a series of commands to the CXL device 204, such as using memory resident queues. The CXL device 204 can retrieve or receive commands from the memory resident queues and execute the commands in an ordered manner. In an example, the host device 202 can specify that a particular command does not begin execution until one or more previous commands complete execution. Such execution ordering can be enforced in the CXL system 200 using a command fencing protocol. In an example, a host or device-side application can be used to impose ordering on a series of commands belonging to a particular queue.

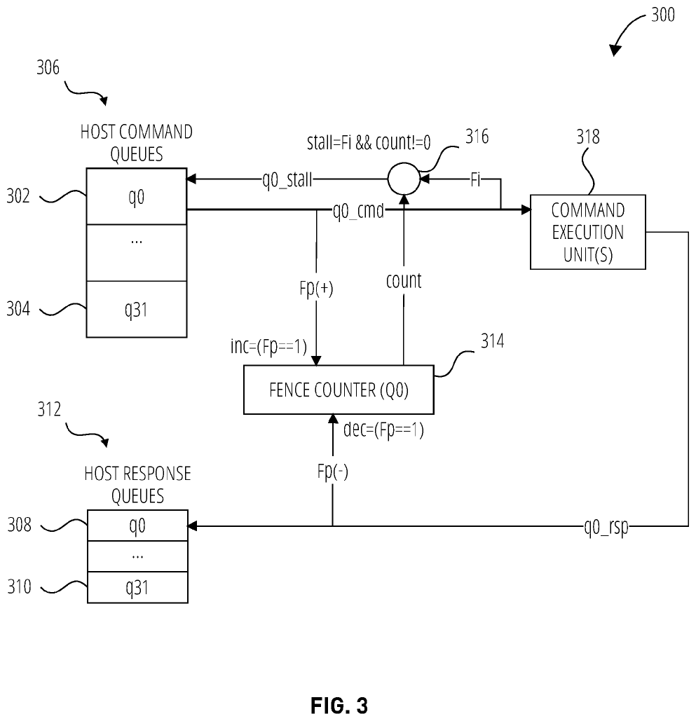

FIG. 3 illustrates generally an example of a command fencing protocol diagram 300. The fencing protocol diagram 300 includes host command queues 306 that can be queued by the host device 202 or the CXL device 204 for execution using one or multiple different command execution unit(s) 318. In the example of FIG. 3, there can be up to thirty-two host command queues 306, designated q0 through q31. The various queues can be sent for execution using command execution unit(s) 318, such as can comprise the accelerator logic 222. Results or responses from the command execution unit(s) 318 can be queued using respective host response queues 312.

In an example, the fencing protocol supports a separate respective command fence for up to thirty-two queues used by host application processes, for example, to send commands to an attached CXL device. The fencing protocol includes or uses a per-queue fence counter 314 and state bits to control the fencing protocol. The state bits can include a fence participant (Fp) bit and a fence initiator (Fi) bit.

The fence participant (Fp) bit comprises a portion of a command packet that specifies whether the corresponding command participates in, or does not participate in, a particular fenced operation or series of fenced operations. If the Fp bit is set (e.g., to 1), then the corresponding command is indicated for execution before a different fenced command can be executed. As commands with their respective Fp bits set are retrieved from the host command queues 306, the fence counter 314 for the corresponding host queue can be incremented.

In an example, the Fp bit can be passed through a processing engine, such as the command execution unit(s) 318, and can be returned in a response message, with the command response, after the command completes execution. The response message, or series or response messages, can be processed and returned to the host application using the host response queues 312. As responses are processed, responses with Fp bits set can cause the fence counter 314 to be decremented. In other words, the fence counter 314 can decrement its count for each response returned from the command execution unit(s) 318 that includes an Fp bit set.

The fence initiator (Fi) bit comprises a portion of a command packet that specifies whether the corresponding command will initiate a new fence for a series of operations. If the Fi bit is set (e.g., to 1), then the corresponding command stalls or waits to execute until all previous packets having Fp bits set complete execution. As a packet with the Fi bit set is processed, a value of the fence counter 314 for the corresponding host queue can be checked. If the fence counter 314 is equal to 0, then all previous Fp packets can be known to have completed execution and the packet with the Fi bit set can proceed.

In an example, if the fence counter 314 is not equal to 0, then at least one of the previous packets with its Fp bit set can be known, or assumed to be, undergoing execution, and the packet with the Fi bit set can be stalled. Furthermore, any packets behind the packet with the Fi bit set can be stalled. As response messages with Fp bits set are returned, the fence counter 314 for the queue can be decremented. When the fence counter 314 reaches 0, then the packet with the Fi bit set can proceed and command traffic processing from the queue(s) can resume.

In an example, the fencing protocol can allow some command packets to flow after reception of a particular packet with its Fi bit set. In this example, subsequent packets from the queue that have Fi and Fp bits not set (e.g., Fi and Fp bits are each set to 0) can be allowed to bypass any stalled packet with an Fi bit set. Reception of a further subsequent packet with either its Fp or Fi bit set can then cause a stall in which no packets from the queue can advance until the fence counter 314 decrements to zero.

The example of FIG. 3 shows a particular command flow for an example first command q0_cmd of a first command queue 302 (q0). Whether the first command includes an Fp or Fi bit set determines whether or when the first command is provided to the command execution unit(s) 318. In some examples, the first command q0_cmd can include a transaction identifier (TID) that uniquely identifies the command and its corresponding response.

In a first example, if the first command includes its Fp bit set and its Fi bit not set, then the first command can be provided to the command execution unit(s) 318 and the fence counter 314 for the first queue can be incremented (e.g., from zero or from a non-zero value). The fence counter 314 will then have a non-zero value. If a later-received command with its Fp bit set arrives, then such command can be allowed to proceed and the fence counter 314 can be further incremented. If a later-received command with its Fi bit set arrives, then such command can be stalled or queued because the non-zero value of the fence counter 314 indicates that fenced operations are ongoing. In response to the first command, the command execution unit(s) 318 can provide a first response message q0_rsp having a corresponding Fp bit set. The first response message can then be received at the host response queues 312 and the fence counter 314 can be decremented.

In a second example, if the first command includes its Fi bit set, then the first command can be stalled unless or until the fence counter 314 is zero. For example, the fencing protocol can include a stall check 316. The stall check 316 can determine whether a particular command is to be stalled, for example, due to ongoing fenced operations. In the example of FIG. 3, a command can be stalled when the Fi bit of the command is set and the value of the fence counter 314 is non-zero. If the Fi bit of the command is set and the value of the fence counter 314 is zero, then it can known or assumed that no fenced operations are underway and the corresponding command can be allowed to proceed.

In a third example, if the Fp and the Fi bits of the first command are not set, then the first command can be permitted to proceed without regard for a value or status of the fence counter 314 or any other fenced operations that may be underway. In this third example, the first command can be allowed to proceed independently because the command does not participate in a fenced operation and does not initiate a new fence. That is, commands without a relationship to an existing queue or thread can be allowed to pass through to the command execution unit without being stopped or blocked. This mechanism thus allows for tuning how the fencing protocol is used to selectively stop command traffic. In a particular example, a data move operation may not require fencing, and thus can be permitted to flow freely through the command execution unit because its result or response may not influence other operations or other results in the queue.

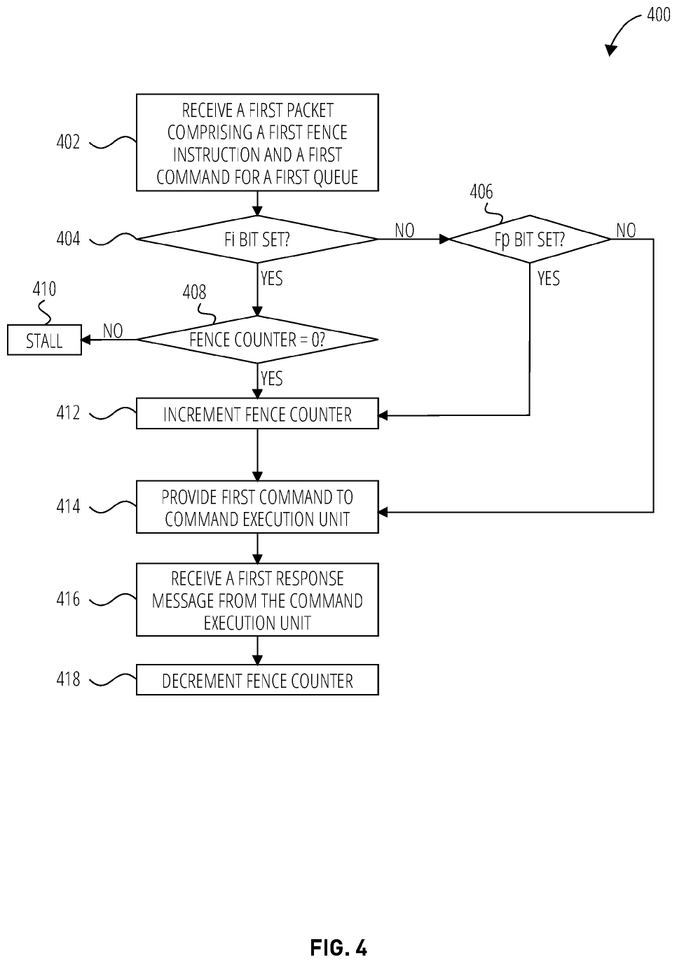

FIG. 4 illustrates generally a first fencing protocol example 400. The first fencing protocol example 400 can include or follow the various fencing rules shown in the fencing protocol diagram 300. At block 402, the first fencing protocol example 400 includes using a command manager to receive a first packet that comprises a first fence instruction and a first command for a first queue. The first fence instruction can include a fence participant bit (Fp), a fence initiator bit (Fi), or both a fence participant and fence initiator bit.

Following block 402, the example can continue with conditionally incrementing a fence counter depending on the content of the Fp and Fi bits. At decision block 404, the first fencing protocol example 400 can include determining whether the fence initiator (Fi) bit is set (e.g., set to 1) or not set. If the Fi bit is set, indicating initiation of a new fence, then the example can advance to decision block 408 to determine a value of a fence counter. If the fence counter is zero, then no fenced operations are underway and the first command can be allowed to proceed and establish a new fence. Accordingly, at block 412, the fence counter can be incremented. If, at decision block 408, the fence counter is nonzero, then the first command can be stalled at 410.

Returning to decision block 404, if the Fi bit is not set, then the example can continue at decision block 406. At decision block 406, the first fencing protocol example 400 can include determining whether the fence participant (Fp) bit is set (e.g., set to 1) or not set. If the Fp bit is set, indicating participation in a fence, then the example can advance to block 412 and increment the fence counter. If the Fp bit is not set, then the first command can be provided to the command execution unit at block 416.

In an example, the fence counter includes a different counter for each of multiple different queues. That is, the fence counter for the first command of the first queue can be a first fence counter that is different than a second fence counter for a different second command of a second queue, and so on. The queue-specific fence counter can be incremented at block 412 when the fence initiator bit or fence participant bit is set in the corresponding command, such as in the first fence instruction.

At block 414, the first fencing protocol example 400 can include providing the first command to a command execution unit. Block 414 can include passing the fence participant bit to or through the command execution unit together with other operands or instructions of the first command. In an example, the CM can stall other commands, belonging to the same first queue or other queues, while the command execution unit operates on or performs the first command.

At block 416, the first fencing protocol example 400 can include receiving a first response message from the command execution unit. In an example, the first response message can include the fence participant bit that was passed to the command execution unit with the first command (e.g., at block 414). Based on the fence participant bit in the first response message, the queue-specific fence counter can be decremented at block 418. If the counter value is zero following block 418, then the protocol can allow receipt or processing of a new command with its corresponding fence initiator bit set to establish a new command fence. If the counter value is not zero following block 418, then the protocol can receive or process other commands that belong to the same queue.

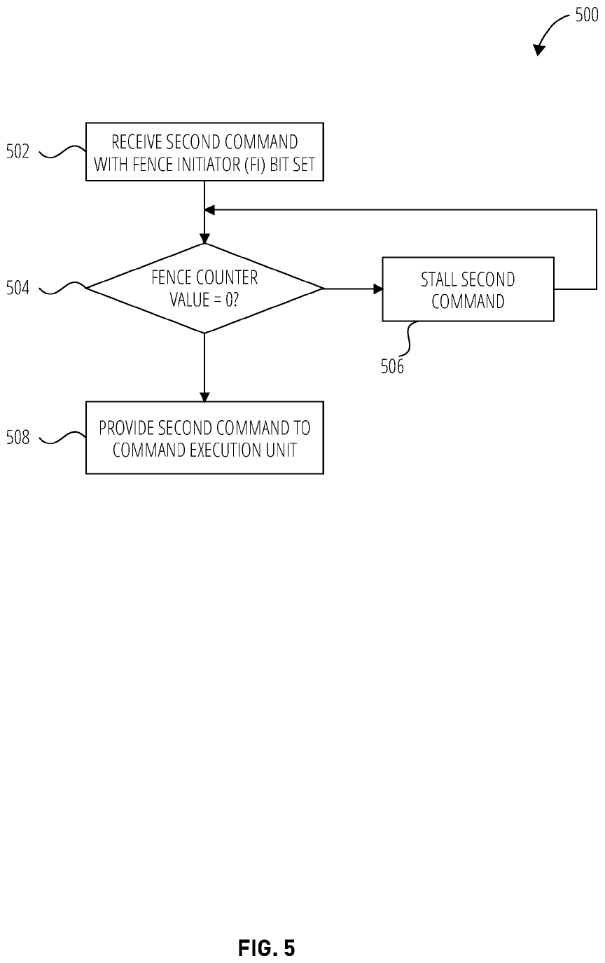

FIG. 5 illustrates generally a second fencing protocol example 500. The second fencing protocol example 500 can include or follow the various fencing rules shown in the fencing protocol diagram 300. At block 502, the second fencing protocol example 500 includes receiving a second command at a command manager. In an example, the second command comprises a packet belonging to the same first queue from the example of FIG. 4 or it can comprise a packet belonging to a different queue. The second command can include a fence instruction with a fence initiator (Fi) bit that is set. The Fi bit can indicate that the second command initiates a new fence to enforce ordering of multiple different commands.

At decision block 504, the second fencing protocol example 500 can determine whether a fence counter value is zero or non-zero. If the fence counter value is non-zero, then a command execution unit resource can be unavailable, for example, because it may be occupied by a different, fenced command or operation, and the second fencing protocol example 500 can continue at block 506. At block 506, the second command can be stalled. For example, the second command can be re-queued in a host queue or buffer or can be otherwise delayed. The stalled second command can be stored (e.g., locally) with visibility to the fence counter such that when the fence counter value reaches zero, the second command can be retrieved and provided to the command execution unit.

If, following decision block 504, the fence counter value is zero, then the command execution unit resource can be available to process the second command. Therefore, at block 508, the second fencing protocol example 500 can include providing the second command to the command execution unit.

In the example of FIG. 5, the fence participant (Fp) bit of the second command may or may not be set. If the Fp bit is set, then the fence counter value can be incremented in coordination with providing the second command to the command execution unit at block 508. A response or result can be returned from the command execution unit in response to the second command and the fence counter value can be correspondingly decremented. The counter increment and decrement operations can be performed before, during, or after any operation by the command execution unit.

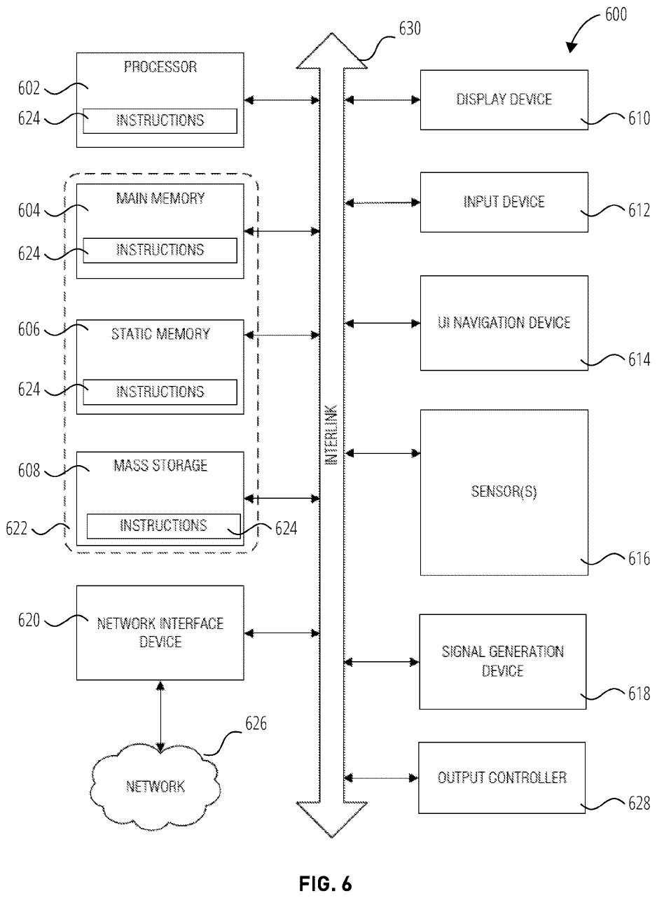

FIG. 6 illustrates a block diagram of an example machine 600 with which, in which, or by which any one or more of the techniques (e.g., methodologies) discussed herein can be implemented. Examples, as described herein, can include, or can operate by, logic or a number of components, or mechanisms in the machine 600. Circuitry (e.g., processing circuitry) is a collection of circuits implemented in tangible entities of the machine 600 that include hardware (e.g., simple circuits, gates, logic, etc.). Circuitry membership (e.g., as belonging to a host-side device or process, or to an accelerator-side device or process) can be flexible over time. Circuitries include members that can, alone or in combination, perform specified operations when operating. In an example, hardware of the circuitry can be immutably designed to carry out a specific operation (e.g., hardwired) for example using the accelerator logic 222 or using a specific command execution unit thereof. In an example, the hardware of the circuitry can include variably connected physical components (e.g., command execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time.

In alternative embodiments, the machine 600 can operate as a standalone device or can be connected (e.g., networked) to other machines. In a networked deployment, the machine 600 can operate in the capacity of a server machine, a client machine, or both in server-client network environments. In an example, the machine 600 can act as a peer machine in peer-to-peer (P2P) (or other distributed) network environment. The machine 600 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Any one or more of the components of the machine 600 can include or use one or more instances of the host device 202 or the CXL device 204 or other component in or appurtenant to the computing system 100. The machine 600 (e.g., computer system) can include a hardware processor 602 (e.g., the host processor 214, the accelerator logic 222, a central processing unit (CPU), a graphics processing unit (GPU), a hardware processor core, or any combination thereof), a main memory 604, a static memory 606 (e.g., memory or storage for firmware, microcode, a basic-input-output (BIOS), unified extensible firmware interface (UEFI), etc.), and mass storage device 608 or memory die stack, hard drives, tape drives, flash storage, or other block devices) some or all of which can communicate with each other via an interlink 630 (e.g., bus). The machine 600 can further include a display device 610, an alphanumeric input device 612 (e.g., a keyboard), and a user interface (UI) Navigation device 614 (e.g., a mouse). In an example, the display device 610, the input device 612, and the UI navigation device 614 can be a touch screen display. The machine 600 can additionally include a mass storage device 608 (e.g., a drive unit), a signal generation device 618 (e.g., a speaker), a network interface device 620, and one or more sensor(s) 616, such as a global positioning system (GPS) sensor, compass, accelerometer, or other sensor. The machine 600 can include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the hardware processor 602, the main memory 604, the static memory 606, or the mass storage device 608 can be, or include, a machine-readable media 622 on which is stored one or more sets of data structures or instructions 624 (e.g., software) embodying or used by any one or more of the techniques or functions described herein. The instructions 624 can also reside, completely or at least partially, within any of registers of the hardware processor 602, the main memory 604, the static memory 606, or the mass storage device 608 during execution thereof by the machine 600. In an example, one or any combination of the hardware processor 602, the main memory 604, the static memory 606, or the mass storage device 608 can constitute the machine-readable media 622. While the machine-readable media 622 is illustrated as a single medium, the term “machine-readable medium” can include a single medium or multiple media (e.g., a centralized or distributed database, or associated caches and servers) configured to store the one or more instructions 624.

The term “machine readable medium” can include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples can include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., electrically programmable read-only memory (EPROM), electrically erasable programmable read-only memory (EEPROM)) and flash memory devices; magnetic disks, such as internal hard disks and removable disks; magneto-optical disks; and CD-ROM and DVD-ROM disks.

In an example, information stored or otherwise provided on the machine-readable media 622 can be representative of the instructions 624, such as instructions 624 themselves or a format from which the instructions 624 can be derived. This format from which the instructions 624 can be derived can include source code, encoded instructions (e.g., in compressed or encrypted form), packaged instructions (e.g., split into multiple packages), or the like. The information representative of the instructions 624 in the machine-readable media 622 can be processed by processing circuitry into the instructions to implement any of the operations discussed herein. For example, deriving the instructions 624 from the information (e.g., processing by the processing circuitry) can include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 624.

In an example, the derivation of the instructions 624 can include assembly, compilation, or interpretation of the information (e.g., by the processing circuitry) to create the instructions 624 from some intermediate or preprocessed format provided by the machine-readable media 622. The information, when provided in multiple parts, can be combined, unpacked, and modified to create the instructions 624. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 624 can be further transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), plain old telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, pccr-to-pccr (P2P) networks, among others. In an example, the network interface device 620 can include one or more physical jacks (e.g., Ethernet, coaxial, or phone jacks) or one or more antennas to connect to the network 626. In an example, the network interface device 620 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software. A transmission medium is a machine readable medium.

To better illustrate the methods and apparatuses described herein, such as can be used to invoke and enforce a command fencing protocol to ensure ordered execution of particular commands, a non-limiting set of Example embodiments are set forth below as numerically identified Examples.

Example 1 is a method comprising receiving a first packet at a command manager, the first packet comprising a first fence instruction and a first command for a first queue, wherein the command manager is configured to enforce respective command execution policies for each of multiple queues according to respective fence instructions. In Example 1, responsive to the first fence instruction indicating fence participation, the method includes incrementing a fence counter and providing the first command to a command execution unit, and receiving, at a response queue, a first response message from the command execution unit based on the first command. Example 1 can further include decrementing the fence counter in coordination with receiving the first response message.

In Example 2, the subject matter of Example 1 includes providing the first command to the command execution unit, including providing the first command to a processor in the command manager, to a data mover, or to a processor outside of the command manager.

In Example 3, the subject matter of Examples 1-2 includes, responsive to the first fence instruction indicating fence initiation, determining a counter value of the fence counter, and responsive to the counter value indicating a different fenced operation is underway, stalling the first command. Responsive to the counter value indicating a new fenced operation can proceed, Example 3 can include incrementing the fence counter and providing the first command to the command execution unit.

In Example 4, the subject matter of Example 3 includes the fence instruction comprising a message field including a first bit indicating fence participation and a second bit indicating fence initiation.

In Example 5, the subject matter of Examples 1-4 includes, responsive to the first fence instruction indicating fence initiation, determining a counter value of the fence counter, the fence counter corresponding to the first queue, and responsive to the counter value indicating a different fenced operation is underway, stalling the first command, and responsive to the counter value indicating a new fenced operation can proceed, incrementing the fence counter corresponding to the first queue and providing the first command to a specified one of multiple available command execution units.

In Example 6, the subject matter of Examples 1-5 includes receiving the first packet at the command manager, including receiving the first packet at a memory-based queue established by a host application.

In Example 7, the subject matter of Examples 1-6 includes providing the first command to the command execution unit, including communicating the first command from a host device to an accelerator device using a compute express link (CXL) interconnect.

In Example 8, the subject matter of Examples 1-7 includes providing the first command to the command execution unit includes using an unordered interconnect that provides respective transaction identifiers (TID) to command and response message pairs, including a first TID for a first pair comprising the first command and the first response message.

In Example 9, the subject matter of Examples 1-8 includes receiving a second packet at the command manager, the second packet comprising a second fence instruction and a second command for the first queue. Responsive to information in the second fence instruction, Example 9 can include selectively providing the second command to the command execution unit or stalling the second command.

In Example 10, the subject matter of Example 9 includes providing the second command to the command execution unit, without regard for a status of a previously-stalled command, when the second fence instruction indicates non-participation in a fence and the second fence instruction indicates non-initiation of a fence.

In Example 11, the subject matter of Examples 1-10 includes receiving a second packet at the command manager, the second packet comprising a second fence instruction and a first command for a second queue, and the command manager can be configured to maintain separate fence policies for transactions from the first and second queues.

Example 12 is a system comprising a memory device and a command manager configured to enforce respective command execution policies for each of multiple queues according to respective command fence instructions. In Example 12, the command manager is configured to receive a first packet comprising a first fence instruction and a first command for a first queue, and responsive to the first fence instruction indicating fence participation, increment a fence counter and provide the first command to a memory controller of the memory device. In Example 12, the command manager is configured to receive a first response message from the memory controller based on the first command and to correspondingly decrement the fence counter.

In Example 13, the subject matter of Example 12 includes the memory device comprising the command manager.

In Example 14, the subject matter of Example 13 includes the command manager coupled to the memory controller using a compute express link (CXL) interconnect.

In Example 15, the subject matter of Examples 12-14 includes the command manager further configured to, responsive to the first fence instruction indicating fence initiation, determine a value of the fence counter, the value indicating whether the memory controller is occupied by a previous command, and responsive to the value indicating the memory controller is occupied, stall the first command until the value indicates the memory controller is unoccupied, and responsive to the value indicating the memory controller is unoccupied, increment the fence counter and provide the first command to the memory device.

Example 16 is at least one non-transitory machine-readable storage medium comprising instructions that, when executed by a processor circuit of a memory system, cause the processor circuit to perform operations comprising receiving or retrieving command packets from a memory-based command queue, wherein each command packet comprises respective instructions for a per-queue command fence, and responsive to a fence initiation instruction in a first packet of the command packets, determining a counter value of a fence counter, the counter value indicating whether a fenced operation is underway, and responsive to the counter value indicating a new fenced operation can proceed, incrementing the counter value of the fence counter and providing a command from the first packet to the command execution unit. Responsive to a fence initiation instruction in a second packet of the command packets, Example 16 can include determining the counter value of the fence counter indicates a different fenced operation is underway and withholding a command from the second packet from the command execution unit. In Example 16, the first and second packets can comprise portions of the same queue.

In Example 17, the subject matter of Example 16 includes instructions that, when executed by the processor circuit, cause the processor circuit to perform operations comprising receiving, at a response queue, a first response message from the command execution unit based on the command from the first packet, and decrementing the counter value of the fence counter, and releasing one or more commands from the second packet to the command execution unit. In an example, the first response message is associated with the command from the first packet using a transaction identifier (TID).

In Example 18, the subject matter of Examples 16-17 includes instructions that, when executed by the processor circuit, cause the processor circuit to perform operations comprising, responsive to a fence participation instruction in a third packet of the command packets and while continuing to withhold the command from the second packet, incrementing the counter value of the fence counter, and providing a command from the third packet to the command execution unit.

In Example 19, the subject matter of Example 18 includes instructions that, when executed by the processor circuit, cause the processor circuit to perform operations comprising decrementing the counter value of the fence counter when a response message is received from the command execution unit based on the command from the first packet or the third packet.

In Example 20, the subject matter of Examples 16-19 includes instructions that, when executed by the processor circuit, cause the processor circuit to perform operations comprising retrieving a third packet of the command packets, the third packet comprising fence instructions that indicate non-participation in a fence and non-initiation of a new fence, and providing a command from the third packet to the command execution unit.

Example 21 is at least one machine-readable medium including instructions that, when executed by processing circuitry, cause the processing circuitry to perform operations to implement of any of Examples 1-15.

Example 22 is an apparatus comprising means to implement of any of Examples 1-20.

Example 23 is a system to implement of any of Examples 1-20.

Example 24 is a method to implement of any of Examples 12-15.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method comprising:
receiving a first packet at a command manager, the first packet comprising a first fence instruction and a first command for a first queue, wherein the command manager is configured to enforce respective command execution policies for each of multiple queues according to respective fence instructions;
responsive to the first fence instruction indicating fence participation, incrementing a fence counter and providing the first command to a command execution unit; and
receiving, at a response queue, a first response message from the command execution unit based on the first command; and
decrementing the fence counter in coordination with receiving the first response message.

2. The method of claim 1, wherein providing the first command to the command execution unit includes providing the first command to a processor in the command manager, to a data mover, or to a processor outside of the command manager.

3. The method of claim 1, comprising:
responsive to the first fence instruction indicating fence initiation:
determining a counter value of the fence counter;
responsive to the counter value indicating a different fenced operation is underway, stalling the first command; and
responsive to the counter value indicating a new fenced operation can proceed, incrementing the fence counter and providing the first command to the command execution unit.

4. The method of claim 3, wherein the fence instruction comprises a message field including a first bit indicating fence participation and a second bit indicating fence initiation.

5. The method of claim 1, comprising:
responsive to the first fence instruction indicating fence initiation:
determining a counter value of the fence counter, the fence counter corresponding to the first queue;
responsive to the counter value indicating a different fenced operation is underway, stalling the first command; and
responsive to the counter value indicating a new fenced operation can proceed, incrementing the fence counter corresponding to the first queue and providing the first command to a specified one of multiple available command execution units.

6. The method of claim 1, wherein receiving the first packet at the command manager includes receiving the first packet at a memory-based queue established by a host application.

7. The method of claim 1, wherein providing the first command to the command execution unit includes communicating the first command from a host device to an accelerator device using a compute express link (CXL) interconnect.

8. The method of claim 1, wherein providing the first command to the command execution unit includes using an unordered interconnect that provides respective transaction identifiers (TID) to command and response message pairs, including a first TID for a first pair comprising the first command and the first response message.

9. The method of claim 1, comprising:
receiving a second packet at the command manager, the second packet comprising a second fence instruction and a second command for the first queue; and
responsive to information in the second fence instruction, selectively providing the second command to the command execution unit or stalling the second command.

10. The method of claim 9, comprising providing the second command to the command execution unit, without regard for a status of a previously-stalled command, when the second fence instruction indicates non-participation in a fence and the second fence instruction indicates non-initiation of a fence.

11. The method of claim 1, comprising receiving a second packet at the command manager, the second packet comprising a second fence instruction and a first command for a second queue, wherein the command manager is configured to maintain separate fence policies for transactions from the first and second queues.

12. A system comprising:
a memory device; and
a command manager configured to enforce respective command execution policies for each of multiple queues according to respective command fence instructions, wherein the command manager is further configured to:
receive a first packet comprising a first fence instruction and a first command for a first queue;
responsive to the first fence instruction indicating fence participation, increment a fence counter and provide the first command to a memory controller of the memory device; and
receive a first response message from the memory controller based on the first command and decrement the fence counter.

13. The system of claim 12, wherein the memory device comprises the command manager.

14. The system of claim 13, wherein the command manager is coupled to the memory controller using a compute express link (CXL) interconnect.

15. The system of claim 12, wherein the command manager is further configured to:
responsive to the first fence instruction indicating fence initiation:
determine a value of the fence counter, the value indicating whether the memory controller is occupied by a previous command;
responsive to the value indicating the memory controller is occupied, stall the first command until the value indicates the memory controller is unoccupied; and
responsive to the value indicating the memory controller is unoccupied, increment the fence counter and provide the first command to the memory device.

16. At least one non-transitory machine-readable storage medium comprising instructions that, when executed by a processor circuit of a memory system, cause the processor circuit to perform operations comprising:
retrieving command packets from a memory-based command queue, wherein each command packet comprises respective instructions for a per-queue command fence;
responsive to a fence initiation instruction in a first packet of the command packets:
determining a counter value of a fence counter, the counter value indicating whether a fenced operation is underway; and
responsive to the counter value indicating a new fenced operation can proceed, incrementing the counter value of the fence counter and providing a command from the first packet to the command execution unit; and
responsive to a fence initiation instruction in a second packet of the command packets:
determining the counter value of the fence counter indicates a different fenced operation is underway; and
withholding a command from the second packet from the command execution unit;
wherein the first and second packets comprise portions of the same queue.

17. The non-transitory machine-readable storage medium of claim 16, wherein the instructions, when executed by the processor circuit, cause the processor circuit to perform operations comprising:
receiving, at a response queue, a first response message from the command execution unit based on the command from the first packet;
decrementing the counter value of the fence counter; and
releasing one or more commands from the second packet to the command execution unit.

18. The non-transitory machine-readable storage medium of claim 16, wherein the instructions, when executed by the processor circuit, cause the processor circuit to perform operations comprising:
responsive to a fence participation instruction in a third packet of the command packets and while continuing to withhold the command from the second packet:
incrementing the counter value of the fence counter; and
providing a command from the third packet to the command execution unit.

19. The non-transitory machine-readable storage medium of claim 18, wherein the instructions, when executed by the processor circuit, cause the processor circuit to perform operations comprising:
decrementing the counter value of the fence counter when a response message is received from the command execution unit based on the command from the first packet or the third packet.

20. The non-transitory machine-readable storage medium of claim 16, wherein the instructions, when executed by the processor circuit, cause the processor circuit to perform operations comprising:
retrieving a third packet of the command packets, the third packet comprising fence instructions that indicate non-participation in a fence and non-initiation of a new fence; and
providing a command from the third packet to the command execution unit.
